(19) United States
(12) Patent Application Publication
(10) Pub. No.: US 2021/0060670 A1
(43) Pub. Date: Mar. 4, 2021

(54) TUBE CUTTER

(71) Applicant: SHIN FU YANG INDUSTRIAL CO., LTD., Taichung (TW)

(72) Inventors: YAO-WEN CHEN, Taichung (TW); SHIH-YANG CHEN, Taichung (TW)

(21) Appl. No.: 16/985,236

(22) Filed: Aug. 5, 2020

(30) Foreign Application Priority Data
Aug. 30, 2019 (TW) 108211606

(51) Int. Cl. B23D 21/08; B23D 33/02; B26D 3/16; B26D 7/04

(52) U.S. Cl. CPC B23D 21/08; B23D 33/025; B26D 2007/013; B26D 7/04; B26D 3/169

(57) ABSTRACT

A tube cutter includes a handle, a carrier, a circular knife, a knob, a threaded rod and a spring. The handle includes an aperture. The carrier is movably connected to the handle, and includes a screw hole. The circular knife is supported on the carrier. The knob is rotationally connected to the handle and includes a non-circular recess. The threaded rod includes a threaded section inserted in the screw hole, a shank inserted in the aperture, and a non-circular head inserted in the non-circular recess. The spring is compressed between the handle and the non-circular head to render the threaded rod smoothly movable relative to the handle.

### BACKGROUND OF INVENTION

### 1. Field of Invention

The present invention relates to tubes and, more particularly, to a tube cutter.

### 2. Related Prior Art

A conventional tube cutter includes a handle, a carrier, a threaded rod, a circular knife, two rollers and a knob. The handle includes two portions extending perpendicular to each other. The first portion of the handle is formed with a dove-tail groove for receiving a dovetail of the carrier so that the carrier is movable relative to the handle. The second portion of the handle includes an aperture for receiving a shank of the threaded rod so that the threaded rod is rotatable relative to the handle. The carrier includes a screw hole for receiving a threaded section of the threaded rod so that the threaded rod is rotatable to move the carrier relative to the handle. The circular knife is supported on the carrier. Two rollers are connected to the second portion of the handle. The knob includes a non-circular recess for receiving a non-circular head of the threaded rod so that the knob is operable to rotate the threaded rod to move the carrier on the handle to adjust a gap between the circular knife and the rollers according to a diameter of a tube to be cut by the tube cutter.

In use, the tube is inserted in the gap between the circular knife and the rollers. The knob is operated to rotate the threaded rod to move the carrier along the handle to reduce the gap between the circular knife and the rollers so that the circular knife and the rollers are in contact with the tube. The handle is operated to rotate the circular knife about the tube for at least one round so that the circular knife cuts into the tube. Again, the knob is operated to rotate the threaded rod to move the carrier along the handle to further reduce the gap between the circular knife and the rollers so that the circular knife and the rollers are in contact with the tube again. Then, the handle is operated to rotate the circular knife about the tube for at least one more round so that the circular knife cuts deeper into the tube. This process is repeated to cause the circular knife to cut off the tube.

However, the dovetail of the carrier inevitably shakes in the dovetail groove. Thus, the movement of the carrier relative to the handle is not smooth.

The present invention is therefore intended to obviate or at least alleviate the problems encountered in the prior art.

### SUMMARY OF INVENTION

It is the primary objective of the present invention to provide a smooth tube cutter.

To achieve the foregoing objective, the tube cutter includes a handle, a carrier, a circular knife, a knob, a threaded rod and a spring. The handle includes an aperture. The carrier is movably connected to the handle, and includes a screw hole. The circular knife is supported on the carrier. The knob is rotationally connected to the handle and includes a non-circular recess. The threaded rod includes a threaded section inserted in the screw hole, a shank inserted in the aperture, and a non-circular head inserted in the non-circular recess. The spring is compressed between the handle and the non-circular head to render the threaded rod smoothly movable relative to the handle.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a tube cutter according to the preferred embodiment of the present invention;

FIG. 2 is a perspective view of the tube cutter shown in FIG. 1;

FIG. 3 is another perspective view of the tube cutter shown in FIG. 1;

FIG. 4 is a cross-sectional view of the tube cutter shown in FIG. 2; and

FIG. 5 is a cross-sectional view of the tube cutter taken along a line A-A in FIG. 4.

### DETAILED DESCRIPTION OF PREFERRED EMBODIMENT

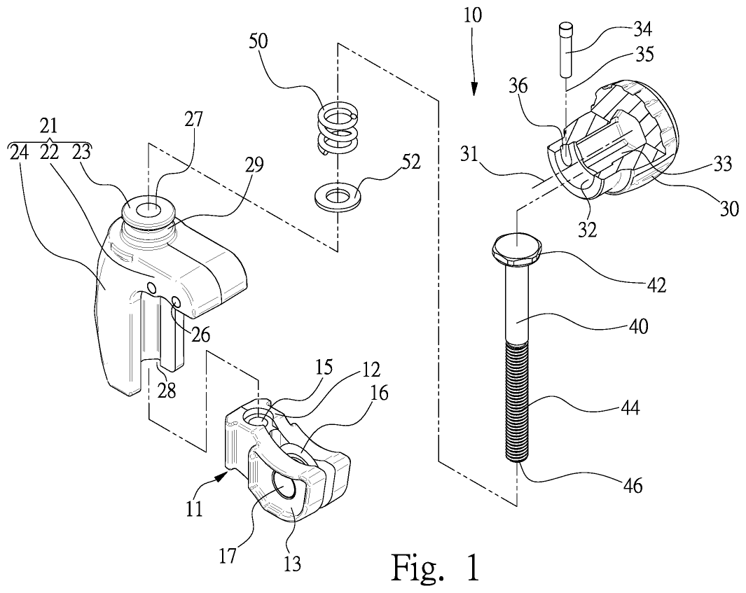

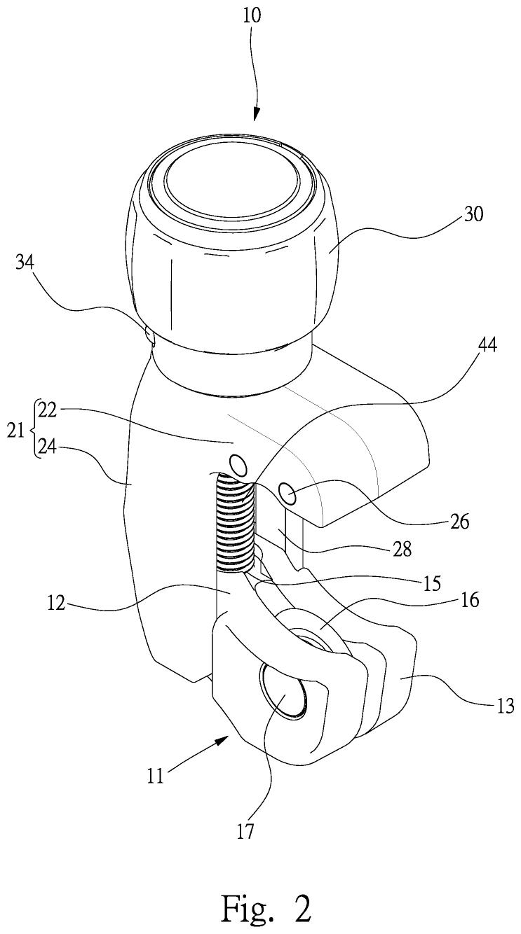

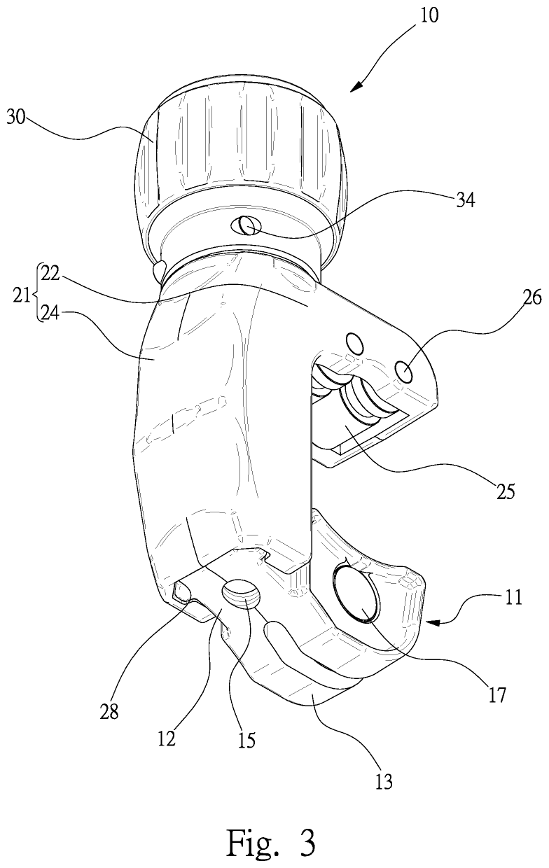

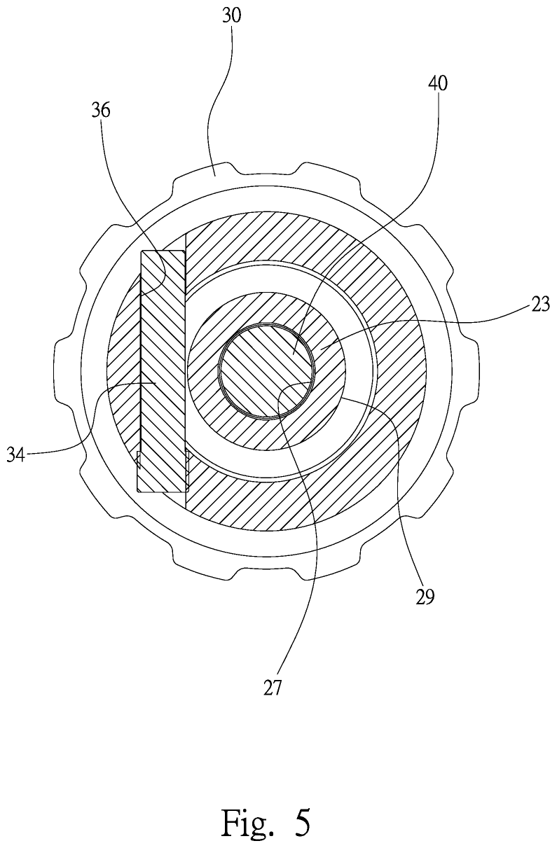

Referring to FIGS. 1 through 5, a tube cutter 10 includes a carrier 11, a handle 21, a knob 30, a threaded rod 40, a spring 50 and a washer 52 according to the preferred embodiment of the present invention. The carrier 11 includes two lugs 13 formed at an end and a dovetail 12 formed at an opposite end. A screw hole 15 is made in the dovetail 12. A circular knife 16 is supported on an axle 17 that is in turn supported on the lugs 13 so that the circular knife 16 is rotatable relative to the lugs 13.

The handle 21 includes a beam 22, a protuberance 23 and a track 24. The beam 22 extends perpendicular to the track 24. The protuberance 23 extends from the beam 22. The protuberance 23 and the track 24 are formed two opposite sides of the beam 22. Two rollers 25 are respectively supported on two axles 26 that are in turn supported on the beam 22. Each of the rollers 25 includes a portion extending out of the beam 22. The track 24 includes a dovetail groove 28 corresponding to the dovetail 12. The beam 22 includes an aperture 27 in communication with the dovetail groove 28. An annular groove 29 is made in the periphery of the protuberance 23.

The dovetail groove 28 of the track 24 receives the dovetail 12 of the carrier 11. Thus, the carrier 11 is movable relative to the handle 21 when the dovetail 12 is movable along the dovetail groove 28. That is, the circular knife 16 is movable toward or from the rollers 25.

The threaded rod 40 includes a shank (not numbered) formed between a non-circular head 42 and a threaded section 44. The threaded section 44 is formed with a free end 46 located opposite to the non-circular head 42. The non-circular head 42 is non-circular, preferably polygonal, and preferably hexagonal.

The free end 46 of the threaded rod 40 is inserted in the dovetail groove 28 of the track 24 through the aperture 27 of the protuberance 23. The shank of the threaded rod 40 is rotationally inserted in the aperture 27 of the protuberance 23. The threaded section 44 is rotationally inserted in the dovetail groove 28. The threaded section 44 is inserted in the screw hole 15 to connect the threaded rod 40 to the carrier 11 and keep the dovetail 12 in the dovetail groove 28.

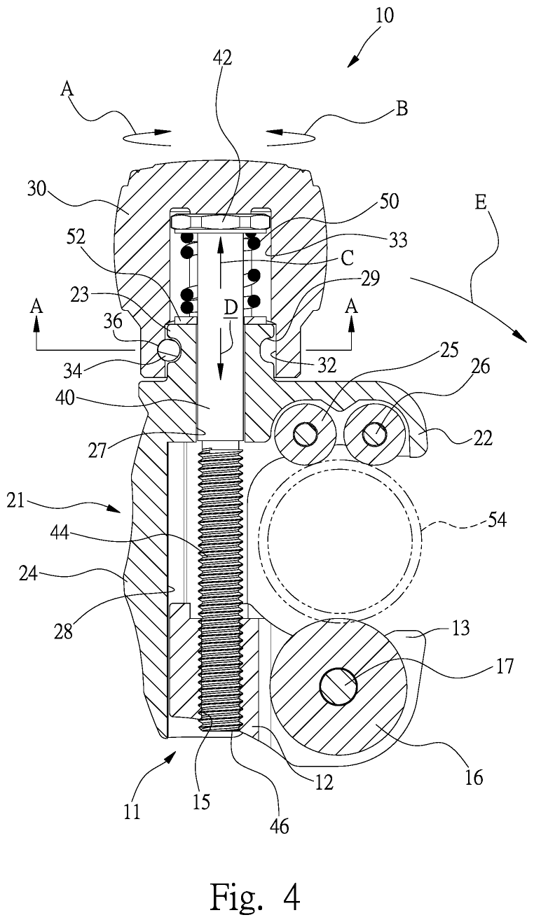

Referring to FIG. 4, the threaded section 44 is rotatable in a sense of direction indicated by an arrow head A so that the carrier 11 is movable toward the beam 22. That is, the circular knife 16 is movable toward the rollers 25 as indicated with an arrow head C. The threaded section 44 is rotatable in an opposite sense of direction indicated with an arrow head B so that the carrier 11 is movable from the beam 22. That is, the circular knife 16 is movable from the rollers 25 as indicated with an arrow head D.

The knob 30 is made with a circular bore 32, a non-circular recess 33 and an orifice 36. The circular bore 32 and the non-circular recess 33 include a common axis 31. The circular bore 32 includes a diameter marginally larger than a diameter of the protuberance 23 to allow insertion of the protuberance 23 into the circular bore 32. The non-circular recess 33 is preferably hexagonal corresponding to the non-circular head 42. The non-circular recess 33 receives the non-circular head 42 so that the knob 30 is rotatable with the threaded rod 40. The orifice 36 includes an axis 35 other than the axis 31.

A pin 34 includes a section inserted in the orifice 36 of the knob 30. The pin 34 includes another section inserted in the annular groove 29. Thus, the knob 30 is kept on the handle 21. The non-circular recess 33 receives the non-circular head 42 to allow translation of the threaded bolt 40 relative to t the knob 30.

The shank of the threaded rod 40 is inserted in the spring 50. The spring 50 is compressed between the non-circular head 42 of the threaded rod 40 and the washer 52, which is in contact with the protuberance 23. Thus, the spring 50 stabilizes the threaded rod 40 and the carrier 11 relative to the handle 21, i.e., suppress shaking of the threaded rod 40 and the circular knife 16 relative to the handle 21.

In use, a tube 54 is located between the carrier 11 and the rollers 25. The knob 30 is operated to rotate the threaded rod 40 to move the carrier 11 relative to the handle 21 to reduce a gap between the circular knife 16 and the rollers 25 so that the circular knife 16 and the rollers 25 are tightly in contact with the tube 54.

The handle 21 is pivoted in a sense of direction indicated by an arrow head E. Thus, the circular knife 16 rotates about the tube 54 for at least one round so that the circular knife 16 cuts into the tube 54.

Again, the knob 30 is operated to rotate the threaded rod 40 to move the carrier 11 relative to the handle 21 to further reduce the gap between the circular knife 16 and the rollers 25 so that the circular knife 16 and the rollers 25 are tightly in contact with the tube 54 again. Again, the handle 21 is operated to rotate the circular knife 16 about the tube 54 for at least one more round so that the circular knife 16 cuts deeper in the tube 54.

In practice, the foregoing process is repeated for several times to cause the circular knife 16 to cut off the tube 54.

To cut a tube with a smaller diameter, the knob 30 is operated to rotate the threaded rod 40 relative to the carrier 11 to bring the circular knife 16 toward the rollers 25. Thus, the circular knife 16 and the rollers 25 are in contact with the tube with the smaller diameter. Then, the handle 21 is pivoted to cause the circular knife 16 to cut into the tube with the smaller diameter.

To cut a tube with a larger diameter, the carrier 11 is moved from the knob 30 to increase the gap between the circular knife 16 and the rollers 25. Thus, the spring 50 is further compressed. The tube with the larger diameter is located between the circular knife 16 and the rollers 25. Then, the carrier 11 is released to allow the spring 50 to move the non-circular head 42 toward the knob 30 to bring the circular knife 16 toward the rollers 25. Thus, the circular knife 16 and the rollers 25 are in contact with the tube with the smaller diameter. Then, the handle 21 is pivoted to cause the circular knife 16 to cut into the tube with the larger diameter.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tube cutter comprising:
a handle comprising an aperture;
a carrier formed with a screw hole and movably connected to the handle;
a circular knife supported on the carrier;
a knob formed with a non-circular recess and rotationally connected to the handle;
a threaded rod comprising a threaded section inserted in the screw hole, a shank inserted in the aperture, and a non-circular head inserted in the non-circular recess to prevent the non-circular head from rotating in the non-circular recess but allow the non-circular head to translate in the non-circular recess; and
a spring compressed between the handle and the non-circular head to render the threaded rod smoothly movable relative to the handle.

2. The tube cutter according to claim 1, wherein the handle comprises a protuberance, wherein the aperture is made in the protuberance, wherein the knob comprises a circular bore for receiving the protuberance to rotationally connect the knob to the handle, wherein the spring is compressed between the protuberance and the non-circular head.

3. The tube cutter according to claim 2, comprising a pin, wherein the knob comprises at least one orifice for receiving at least one section of the pin and the protuberance comprises an annular groove for receiving another section of the pin to keep the knob on the protuberance and allow the knob to rotate about the protuberance.

4. The tube cutter according to claim 1, wherein the non-circular recess is a polygonal recess, the non-circular head is a polygonal portion.

5. The tube cutter according to claim 1, wherein the spring extends around the threaded rod.

6. The tube cutter according to claim 1, comprising a washer extending around the threaded rod, wherein the washer is abutted against the protuberance by the spring.
